(19) United States
(12) Patent Application Publication
(10) Pub. No.: US 2026/0148886 A1
(43) Pub. Date: May 28, 2026

(54) MAGNET DEVICE, MAGNET CONNECTION STRUCTURE, AND MAGNET CONNECTION METHOD

(71) Applicant: SONY GROUP CORPORATION, TOKYO (JP)

(72) Inventors: WATARU NAKANO, TOKYO (JP); HIROMICHI KOJIMA, TOKYO (JP)

(21) Appl. No.: 19/121,666

(22) PCT Filed: Oct. 5, 2023
(86) PCT No.: PCT/JP2023/036332

§ 371 Date: Apr. 16, 2025

(30) Foreign Application Priority Data
Oct. 24, 2022 (JP) 2022-169670

(51) Int. Cl. H01F 7/02; G01P 15/18

(52) U.S. Cl. CPC H01F 7/0221; G01P 15/18

(57) ABSTRACT

A magnet device includes an anisotropic magnet and one or more engaging bodies. The anisotropic magnet guides a magnet surface to a stable rotation posture by magnetic force. One or more engaging bodies position the magnet surface in the rotation posture guided by the magnetic force.

### FIELD

The present invention relates to a magnet device, a magnet connection structure, and a magnet connection method.

### BACKGROUND

There are known products using adsorption of a magnet for mounting and attaching equipment and housing equipment to a charging case. In any of the products, a difference in shape (asymmetry) of the outline of a product is used for positioning of a mounting direction.

### CITATION LIST

### Patent Literature

Patent Literature 1: JP 2003-077587 A

### SUMMARY

### Technical Problem

In the above-described products, equipment needs to be mounted in a correct direction while the mounting direction is visually checked. This imposes an extra burden on a user.

Therefore, the present disclosure proposes a magnet device, a magnet connection structure, and a magnet connection method capable of easily mounting equipment in a correct direction.

### Solution to Problem

According to the present disclosure, a magnet device is provided that comprises: an anisotropic magnet that guides a magnet surface to a stable rotation posture by magnetic force; and one or more engaging bodies that position the magnet surface in the rotation posture.

According to the present disclosure, a magnet connection structure is provided that comprises: a plurality of magnet devices including an anisotropic magnet; and a plurality of engaging bodies that perform positioning by engaging magnet devices, whose rotation postures have been stabilized, with each other by magnetic force acting between the plurality of magnet devices.

According to the present disclosure, a magnet connection method is provided that comprises: causing a plurality of magnet devices having an anisotropic magnet to face each other; and performing positioning by engaging magnet devices, whose rotation postures have been stabilized, with each other by magnetic force acting between the plurality of magnet devices.

### BRIEF DESCRIPTION OF DRAWINGS

FIG. 1 illustrates an example of a magnet connection structure.

FIG. 2 illustrates the example of the magnet connection structure.

FIG. 3 illustrates configurations of a sensor and a charging case.

FIG. 4 illustrates the configurations of the sensor and the charging case.

FIG. 5 illustrates a configuration of a holder.

FIG. 6 illustrates a fixation structure of the sensor.

FIG. 7 illustrates how the sensor is mounted on the holder.

FIG. 8 illustrates an application example of the sensor.

### DESCRIPTION OF EMBODIMENTS

An embodiment of the present disclosure will be described in detail below with reference to the drawings. In the following embodiment, the same reference signs are attached to the same parts to omit duplicate description.

Note that the description will be given in the following order.
[1. Magnet Connection Structure]
[2. Structural Example of Magnet Device]
[2-1. Sensor]
[2-2. Charging Case]
[2-3. Holder]
[2-4. Mounting Example of Sensor]
[2-5. Application Example of Sensor]
[3. Variations]
[4. Effects]

### 1. Magnet Connection Structure

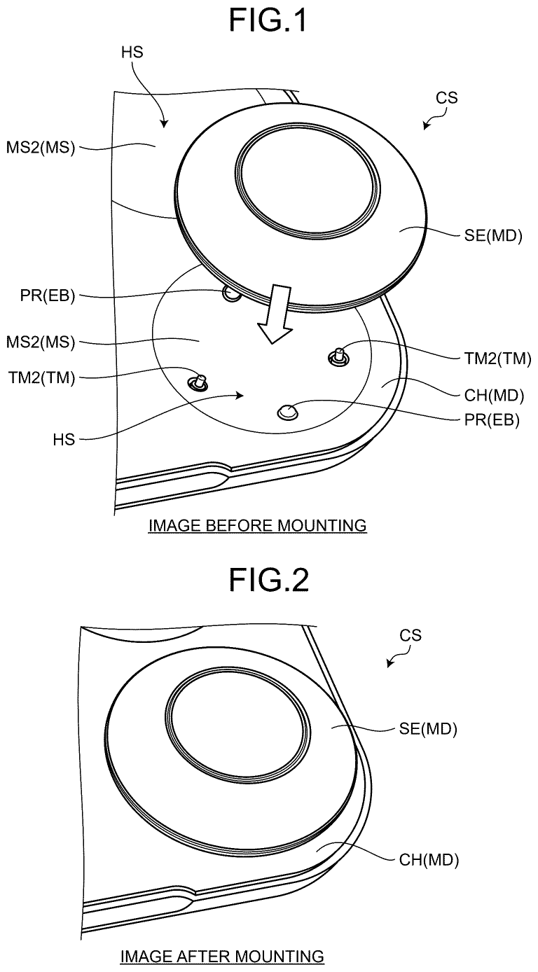

FIGS. 1 and 2 illustrate an example of a magnet connection structure CS.

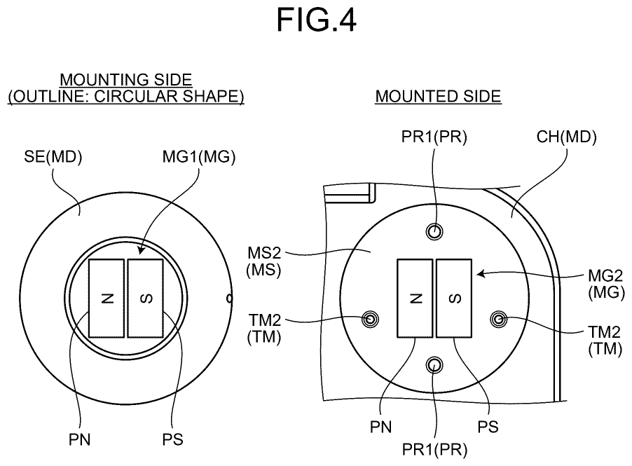

The magnet connection structure CS includes a plurality of magnet devices MD connected by magnetic force. In the example of FIGS. 1 and 2, a sensor SE and a charging case CH are illustrated as the plurality of magnet devices MD. A magnet device MD includes an anisotropic magnet MG (see FIG. 4) and one or more engaging bodies EB. The anisotropic magnet MG is provided at a position facing a magnet surface MS.

The magnet surface MS means a surface connected to another magnet device MD by magnetic force of the anisotropic magnet MG. The anisotropic magnet MG means a magnet in which an S pole PS (see FIG. 4) and an N pole PN (see FIG. 4) are arranged in a direction orthogonal to a direction facing the magnet surface MS (facing direction) when viewed from the facing direction. For example, the anisotropic magnet MG is a magnet sheet magnetized along a sheet surface facing the magnet surface MS. The anisotropic magnet MG guides the magnet surface MS to a stable rotation posture by magnetic force. An engaging body EB positions the magnet surface MS in the rotation posture guided by the magnetic force.

Magnetic force is generated between the plurality of magnet devices MD by anisotropic magnets MD thereof approaching each other. The magnetic force includes attraction and repulsion. The attraction acts between different poles of the anisotropic magnets MD. The repulsion acts between the same poles of the anisotropic magnets MD. The rotation postures of the plurality of magnet devices MD are stabilized such that the different poles thereof face each other by magnetic force acting between the plurality of magnet devices MD.

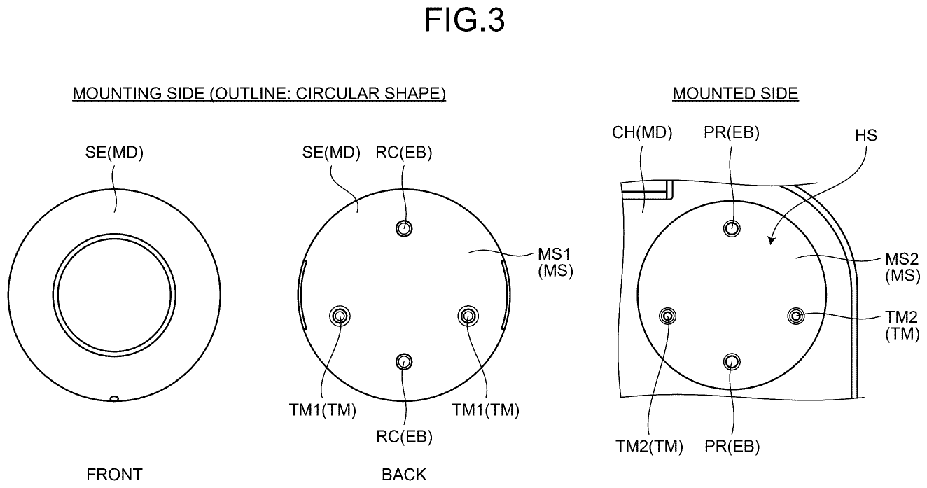

The magnet connection structure CS includes a plurality of engaging bodies EB that position the magnet devices MD. The plurality of engaging bodies EB performs positioning by engaging the magnet devices MD, whose rotation postures have been stabilized, with each other by magnetic force acting between the plurality of magnet devices MD. In the example of FIGS. 1 and 2, the engaging bodies EB are configured as projections PR or recesses RC (see FIG. 3) for engaging the magnet surface MS to another magnet surface MS.

The magnet surfaces MS are electrically and mechanically connected well to each other by the positioning. In the example of FIG. 1, a magnet surface MS of each of the magnet devices MD includes one or more terminals TM for connection with another magnet surface MS. The terminals TM are reliably connected to each other by the positioning.

### 2. Structural Example of Magnet Device

FIGS. 3 and 4 illustrate the configurations of the sensor SE and the charging case CH, which are examples of the magnet devices MD. FIG. 4 illustrates the anisotropic magnet MG fluoroscopically viewed in FIG. 3.

### [2-1. Sensor]

The sensor SE is a motion sensor capable of detecting changes of accelerations of three axes. In the sensor SE, a back surface side connected to the charging case CH corresponds to a magnet surface MS1. An anisotropic magnet MG1 is provided on the inside of the magnet surface MS1 (inner side of sensor SE). The anisotropic magnet MG1 is a rectangular magnet sheet in which a magnetization direction is set along the sheet surface. The magnet surface MS1 has a dome-shaped curved surface portion in which a portion facing the center of the anisotropic magnet MG1 protrudes most. When viewed from a direction facing the anisotropic magnet MG1, the magnet surface MS1 has a circular shape with the position facing the center of the anisotropic magnet MG1 being defined as the center. Note that the “center of the anisotropic magnet” is defined as, for example, the center of gravity of the anisotropic magnet MG.

A plurality of recesses RC for positioning is provided on the magnet surface MS1. In the example of FIG. 3, two recesses RC are provided. The recesses RC function as the engaging bodies EB to be engaged with the projections PR of the charging case CH. The two recesses RC are opposed in a direction orthogonal to the magnetization direction while sandwiching the anisotropic magnet MG1. In the example of FIG. 4, the two recesses RC are arranged on the circumference with the center of the anisotropic magnet MG1 being defined as the center of a circle. The two recesses RC are arranged at point-symmetric positions with respect to the center of the anisotropic magnet MG1.

A plurality of terminals TM1 for charging is provided on the magnet surface MS1. In the example of FIG. 4, two terminals TM1 are provided. The two terminals TM1 are opposed in the magnetization direction while sandwiching the anisotropic magnet MG1.

### [2-2. Charging Case]

The charging case CH includes one or more housings HS capable of housing the sensor SE. The sensor SE is charged by housing the sensor SE in a housing HS. In the charging case CH, a surface of the housing HS on which the sensor SE is mounted corresponds to a magnet surface MS2.

An anisotropic magnet MG2 is provided on the inside of the magnet surface MS2 (inner side of charging case CH). The anisotropic magnet MG2 is a rectangular magnet sheet in which a magnetization direction is set along the sheet surface. The magnet surface MS2 has an inverted-dome-shaped curved surface portion in which a portion facing the center of the anisotropic magnet MG2 is recessed most. When viewed from a direction facing the anisotropic magnet MG2, the magnet surface MS2 has a circular shape with the position facing the center of the anisotropic magnet MG2 being defined as the center.

A plurality of projections PR1 for positioning is provided on the magnet surface MS2. The same number of projections PR1 as the recesses RC are provided. The positional relation between the anisotropic magnet MG2 and the projections PR1 is the same as the positional relation between the anisotropic magnet MG1 and the recesses RC.

A plurality of terminals TM2 for charging is provided on the magnet surface MS2. In the example of FIG. 4, two terminals TM2 are provided. The two terminals TM2 are opposed in the magnetization direction while sandwiching the anisotropic magnet MG2. The terminals TM1 and the terminals TM2 are connected in a state of being accurately positioned by the projections PR1 and the recesses RC engaging with each other.

### [2-3. Holder]

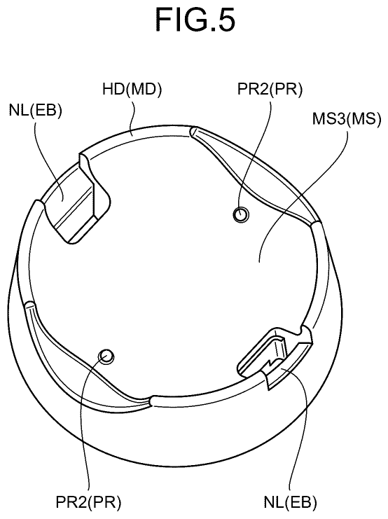

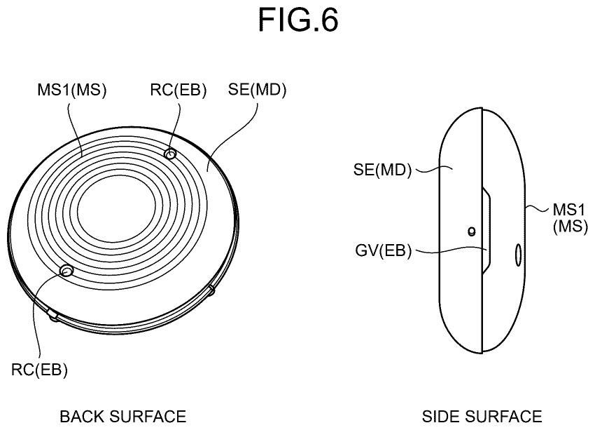

FIG. 5 illustrates a configuration of a holder HD, which is an example of the magnet devices MD. FIG. 6 illustrates a fixation structure of the sensor SE.

The holder HD is mounted on a sensing target (e.g., arm and leg of human) while holding the sensor SE. In the holder HD, a surface on which the sensor SE is mounted corresponds to a magnet surface MS3. Although not illustrated, an anisotropic magnet MG similar to the anisotropic magnet MG2 of the charging case CH is provided on the inside of the magnet surface MS3 (inner side of holder HD). The magnet surface MS3 has an inverted-dome-shaped curved surface portion similar to the magnet surface MS2.

A plurality of projections PR2 for positioning is provided on the magnet surface MS3. The projections PR2 function as the engaging bodies EB to be engaged with the recesses RC of the sensor SE. The number of the projections PR2 and the positional relation between the anisotropic magnet MG and the projections PR2 are similar to those of the charging case CH.

A plurality of nails NL for fixing the sensor SE is provided on an outer peripheral portion of the holder HD. The nails NL engage with a plurality of grooves GV provided on a side surface of the sensor SE to fix the sensor SE to the holder HD. The nails NL and the grooves GV function as the engaging bodies EB for positioning the sensor SE and the holder HD. In the example of FIGS. 5 and 6, two nails NL and two grooves GV are provided. The two nails NL are opposed in the magnetization direction while sandwiching the anisotropic magnet MG. The number and arrangement of the grooves GV are similar to those of the nails NL.

### [2-4. Mounting Example of Sensor]

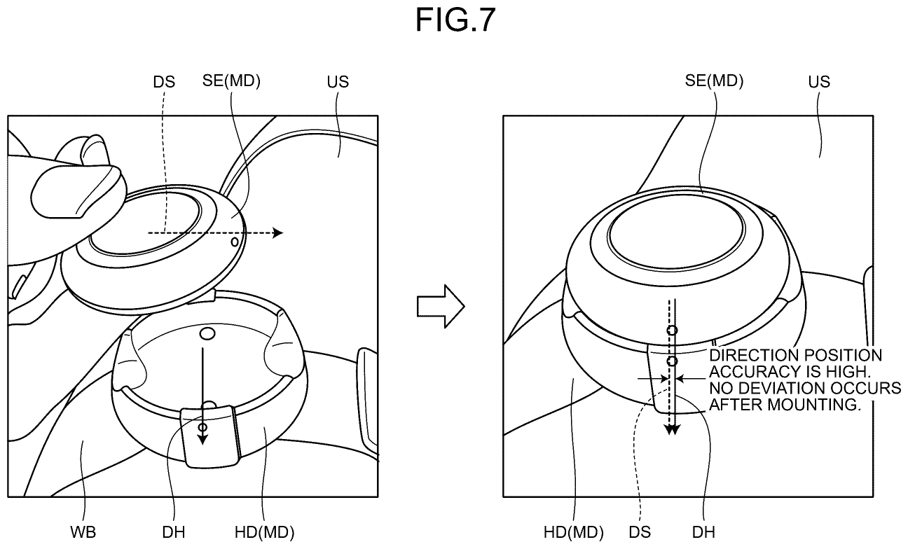

FIG. 7 illustrates how the sensor SE is mounted on the holder HD.

A user US fixes the holder HD on his/her wrist with a wrist band WB, and mounts the sensor SE on the holder HD by magnetic force. Since the sensor SE has a circular shape, it is difficult to mount the sensor SE in a correct direction only by visual observation. In the configuration of the present disclosure, however, the sensor SE is automatically positioned in the correct direction by magnetic force acting between the sensor SE and the holder HD. Therefore, the sensor SE is mounted in the correct direction even if the user US does not become conscious of the mounting direction of the sensor SE.

In the example of FIG. 7, a magnetization direction DS of an anisotropic magnet MG on the side of the sensor SE is orthogonal to a magnetization direction DH of an anisotropic magnet MG on the side of the holder HD. When the sensor SE approaches the holder HD in this state, the sensor SE is rotated by repulsion between the same poles to a position where the magnetization direction DS and the magnetization direction DH are aligned in the same direction. When the rotation posture of the sensor SE is stabilized, the engaging bodies EB provided on the sensor SE and the holder HD perform positioning. Then, the sensor SE is adsorbed to the holder HD by attraction between different poles in a state where positioning is accurately performed.

### [2-5. Application Example of Sensor]

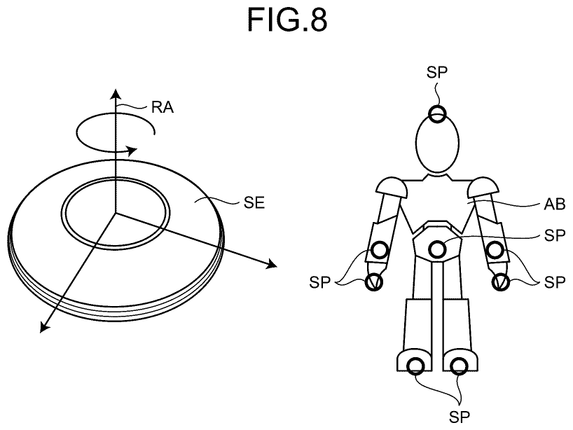

FIG. 8 illustrates an application example of the sensor SE.

The sensor SE functions as a motion sensor that detects the motion of the user US. The sensor SE is mounted on a wrist, an ankle, an elbow, the waist, and the head of the user US. The motion of each portion detected by the sensor SE is converted into the motion of a robot, which is an avatar AB. The sensor SE is mounted on the user US via the holder HD. When the sensor SE is not correctly mounted on the holder HD, an angle around a rotation axis RA cannot be correctly measured. A measurement error of the sensor SE due to a mounting mistake is reduced by adopting the configuration of the present disclosure.

### 3. Variations

Although a specific form of the present disclosure has been described above, the configuration of the present disclosure is not limited to the above-described embodiment. The configuration of the present disclosure can be applied not only to the sensor SE, the charging case CH, and the holder HD described above but to various magnet devices MD in which connection is performed by magnetic force.

Although, in the above-described embodiment, the projections PR, the recesses RC, the nails NL, and the grooves GV are illustrated as the engaging bodies EB, the structures of the engaging bodies EB are not limited thereto. The number and arrangement of the engaging bodies EB are not limited to the above-described embodiment.

Furthermore, in the above-described embodiment, one magnet sheet including the S pole PS and the N pole PN on the sheet surface has been illustrated as the anisotropic magnet MG. The S pole PS and the N pole PN may, however, be configured by separate magnets. For example, the anisotropic magnet MG can be configured by a first magnet and a second magnet. In the first magnet, the S pole PS faces the magnet surface MS. In the second magnet, the N pole PN faces the magnet surface MS.

In the above-described embodiment, an example has been illustrated in which the magnet surface MS is configured as a dome-shaped curved surface portion or an inverted-dome-shaped curved surface portion. The shape of the magnet surface MS is, however, not limited thereto. A part or all of the magnet surface MS may be configured by a flat surface.

For example, the magnet surface MS1 may have a columnar projection with the position facing the center of the anisotropic magnet MG1 being defined as the center of the circle. In this case, the magnet surface MS2 has a columnar recess with the position facing the center of the anisotropic magnet MG2 being defined as the center of the circle. When the columnar projection is inserted into the columnar recess, the magnet surface MS1 is positioned in the correct direction by magnetic force acting between the magnet surface MS1 and the magnet surface MS2.

### 4. Effects

A magnet device of the present disclosure includes an anisotropic magnet MG and one or more engaging bodies EB. The anisotropic magnet MG guides the magnet surface MS to a stable rotation posture by magnetic force. One or more engaging bodies EB position the magnet surface MS in the rotation posture guided by the magnetic force.

This configuration causes the rotation posture of the magnet surface MS to be guided in the correct direction by magnetic force of the anisotropic magnet MG even if the user US does not visually adjust the mounting direction. Therefore, equipment can be easily mounted in the correct direction.

The anisotropic magnet MG is a magnet sheet magnetized along a sheet surface facing the magnet surface MS.

The configuration can reduce the thickness of the anisotropic magnet MG. Therefore, a thin magnet device MD is provided.

The engaging bodies are configured as the projections PR or the recesses RC for engaging the magnet surface MS with another magnet surface MS.

According to the configuration, a magnet device MD capable of accurately performing positioning with a simple configuration is provided.

Two engaging bodies EB are provided.

The configuration enables accurate positioning. An excessively large or small number of engaging bodies EB negatively influence the accuracy of the positioning. For example, if only one engaging body EB is provided, force for fixing the magnet surface MS to a mounting target is weakened. An excessively large number of engaging bodies EB may cause engagement through an erroneous combination of the engaging bodies EB. Two engaging bodies EB make a small number of combinations of the engaging bodies EB, which reduces the possibility of causing engagement through an erroneous combination.

The two engaging bodies EB are opposed while sandwiching the anisotropic magnet MG.

The configuration widens the distance between the engaging bodies EB. A short distance between the engaging bodies EB may cause engagement through an erroneous combination of the engaging bodies EB. A widened distance between the engaging bodies EB reduces the possibility of causing engagement through an erroneous combination.

When viewed from the direction facing the anisotropic magnet MG, the magnet surface MS has a circular shape with the position facing the center of the anisotropic magnet MG being defined as the center.

The configuration smooths rotation of the magnet surface MS with the magnet center being defined as the rotation center.

The magnet surface MS has a dome-shaped curved surface portion in which a portion facing the center of the anisotropic magnet MG (magnet center) protrudes most. Alternatively, the magnet surface MS has an inverted-dome-shaped curved surface portion in which a portion facing the center of the anisotropic magnet MG is recessed most.

The configuration smooths rotation of the magnet surface MS with the magnet center being defined as the rotation center. Therefore, the magnet surface MS is easily guided to a correct rotation posture.

The magnet surface MS may have a columnar projection with the position facing the center of the anisotropic magnet MG being defined as the center of the circle. Alternatively, the magnet surface MS may have a columnar recess with the position facing the center of the anisotropic magnet MG being defined as the center of the circle.

The configuration smooths rotation of the magnet surface MS with the magnet center being defined as the rotation center. Therefore, the magnet surface MS is easily guided to a correct rotation posture.

The magnet surface MS includes one or more terminals TM for connection with another magnet surface MS.

According to the configuration, terminals TM are connected well to each other by the magnet surfaces MS being accurately positioned.

The magnet connection structure CS of the present disclosure includes a plurality magnet devices MD and a plurality of engaging bodies EB for positioning. The magnet device MD includes the anisotropic magnet MG. The plurality of engaging bodies EB performs positioning by engaging the magnet devices MD, whose rotation postures have been stabilized, with each other by magnetic force acting between the plurality of magnet devices MD.

This configuration enables the magnet devices MD to be accurately positioned in the correct direction even if the user US does not visually adjust the mounting direction.

A magnet connection method of the present disclosure includes a rotation step and a positioning step. In the rotation step, a plurality of magnet devices MD including an anisotropic magnet MG is caused to face each other, and the magnet devices MD are relatively rotated by magnetic force. In the positioning step, positioning is performed by engaging the magnet devices MD, whose rotation postures have been stabilized, with each other by magnetic force acting between the plurality of magnet devices MD.

This configuration enables the magnet devices MD to be accurately positioned in the correct direction even if the user US does not visually adjust the mounting direction.

Note that the effects described in the present specification are merely examples and not limitations. Other effects may be obtained.

### [Appendix]

Note that the present technology can also have the configurations as follows.
(1)

A magnet device comprising:
an anisotropic magnet that guides a magnet surface to a stable rotation posture by magnetic force; and
one or more engaging bodies that position the magnet surface in the rotation posture.
(2)

The magnet device according to (1),
wherein the anisotropic magnet is a magnet sheet magnetized along a sheet surface facing the magnet surface.
(3)

The magnet device according to (1) or (2),
wherein each of the engaging bodies is configured as a projection or a recess for engaging the magnet surface with another magnet surface.
(4)

The magnet device according to (3),
wherein two engaging bodies are provided.
(5)

The magnet device according to (4),
wherein the two engaging bodies are opposed while sandwiching the anisotropic magnet.
(6)

The magnet device according to any one of (1) to (5),
wherein, when viewed from a direction facing the anisotropic magnet, the magnet surface has a circular shape with a position facing a center of the anisotropic magnet being defined as a center.
(7)

The magnet device according to (6),
wherein the magnet surface includes a dome-shaped curved surface portion in which a portion facing the center of the anisotropic magnet protrudes most or an inverted-dome-shaped curved surface portion in which the portion facing the center of the anisotropic magnet is recessed most.
(8)

The magnet device according to (6),
wherein the magnet surface includes a columnar projection with a position facing the center of the anisotropic magnet being defined as a center of a circle or a columnar recess with the position facing the center of the anisotropic magnet being defined as the center of the circle.
(9)

The magnet device according to any one of (1) to (8),
wherein the magnet surface includes one or more terminals for connection with another magnet surface.
(10)

A magnet connection structure comprising:
a plurality of magnet devices including an anisotropic magnet; and
a plurality of engaging bodies that perform positioning by engaging magnet devices, whose rotation postures have been stabilized, with each other by magnetic force acting between the plurality of magnet devices.
(11)

A magnet connection method comprising:
causing a plurality of magnet devices having an anisotropic magnet to face each other; and
performing positioning by engaging magnet devices, whose rotation postures have been stabilized, with each other by magnetic force acting between the plurality of magnet devices.

### REFERENCE SIGNS LIST

CS MAGNET CONNECTION STRUCTURE
EB ENGAGING BODY
MD MAGNET DEVICE
MG, MG1, MG2 ANISOTROPIC MAGNET
MS, MS1, MS2, MS3 MAGNET SURFACE
PR PROJECTION
RC RECESS
TM, TM1, TM2 TERMINAL

1. A magnet device comprising:
an anisotropic magnet that guides a magnet surface to a stable rotation posture by magnetic force; and
one or more engaging bodies that position the magnet surface in the rotation posture.

2. The magnet device according to claim 1,
wherein the anisotropic magnet is a magnet sheet magnetized along a sheet surface facing the magnet surface.

3. The magnet device according to claim 1,
wherein each of the engaging bodies is configured as a projection or a recess for engaging the magnet surface with another magnet surface.

4. The magnet device according to claim 3,
wherein two engaging bodies are provided.

5. The magnet device according to claim 4,
wherein the two engaging bodies are opposed while sandwiching the anisotropic magnet.

6. The magnet device according to claim 1,
wherein, when viewed from a direction facing the anisotropic magnet, the magnet surface has a circular shape with a position facing a center of the anisotropic magnet being defined as a center.

7. The magnet device according to claim 6,
wherein the magnet surface includes a dome-shaped curved surface portion in which a portion facing the center of the anisotropic magnet protrudes most or an inverted-dome-shaped curved surface portion in which the portion facing the center of the anisotropic magnet is recessed most.

8. The magnet device according to claim 6,
wherein the magnet surface includes a columnar projection with a position facing the center of the anisotropic magnet being defined as a center of a circle or a columnar recess with the position facing the center of the anisotropic magnet being defined as the center of the circle.

9. The magnet device according to claim 1,
wherein the magnet surface includes one or more terminals for connection with another magnet surface.

10. A magnet connection structure comprising:
a plurality of magnet devices including an anisotropic magnet; and
a plurality of engaging bodies that perform positioning by engaging magnet devices, whose rotation postures have been stabilized, with each other by magnetic force acting between the plurality of magnet devices.

11. A magnet connection method comprising:
causing a plurality of magnet devices having an anisotropic magnet to face each other; and
performing positioning by engaging magnet devices, whose rotation postures have been stabilized, with each other by magnetic force acting between the plurality of magnet devices.
